(19) United States
(12) Patent Application Publication
(10) Pub. No.: US 2026/0121908 A1
(43) Pub. Date: Apr. 30, 2026

(54) METHOD, DEVICE, AND MEDIUM FOR BACKUP AND RESTORATIVE CONNECTIVITY SERVICE

(71) Applicant: Verizon Patent and Licensing Inc., Basking Ridge, NJ (US)

(72) Inventors: Christopher Albano, Medford, NJ (US); Matthew Scott Deatrick, Oak Ridge, NJ (US); Yuk Lun Li, Morganville, NJ (US)

(21) Appl. No.: 18/933,283

(22) Filed: Oct. 31, 2024

(51) Int. Cl. H04L 41/0663; H04L 47/24

(52) U.S. Cl. CPC H04L 41/0663; H04L 47/24

(57) ABSTRACT

A method, a network device, and a non-transitory computer-readable storage medium are described in relation to a backup and restorative connectivity service. The backup and restorative connectivity service may provide intelligent access and use of a temporary connection, which may have a lower capacity than the primary network connection, when a primary network connection is down due to a power or network outage. The backup and restorative connectivity service may manage switchovers between the primary network connection and the temporary connection regarding traffic of all connected end devices. The service may include the generation of communication scheduling based on various types of data, end user usage patterns and rules, machine learning, and optimization criteria.

### BACKGROUND

Development and design of networks present certain challenges from a network-side perspective and an end device perspective. For example, when a network suffers a failure or is subject to a power outage, various procedures may need to be developed to address the failure or outage and/or mitigate the impact on end device connectivity.

### BRIEF DESCRIPTION OF THE DRAWINGS

FIG. 1 is a diagram illustrating an exemplary environment in which an exemplary embodiment of a backup and restorative connectivity service may be implemented;

FIG. 2A is a diagram illustrating another exemplary environment in which an exemplary embodiment of a backup and restorative connectivity service may be implemented according to an exemplary scenario;

FIG. 2B is a diagram illustrating exemplary functional components of a device configured to provide an exemplary embodiment of the backup and restorative connectivity service;

FIGS. 2C-2E are diagrams illustrating an exemplary process of an exemplary embodiment of the backup and restorative connectivity service;

FIG. 3 is a diagram illustrating exemplary components of a device that may correspond to one or more of the devices illustrated and described herein;

FIG. 4 is a flow diagram illustrating an exemplary process of an exemplary embodiment of the backup and restorative connectivity service; and

FIG. 5 is a flow diagram illustrating another exemplary process of an exemplary embodiment of the backup and restorative connectivity service.

### DETAILED DESCRIPTION

The following detailed description refers to the accompanying drawings. The same reference numbers in different drawings may identify the same or similar elements. Also, the following detailed description does not limit the invention.

For various reasons related to infrastructure, maintenance, weather, accidents, cyberattacks, security breaches, device failures, faulty cables, and/or connections, among other types of issues, there is always a chance of a network outage (e.g., a broadband Internet connection or the like) in the future. Additionally, a user may expect hours of power disruption each year at their home or place of business, due to other infrastructure providers, for example. In some of those cases, a user may need to reboot their customer premise equipment (CPE), such as a router, a modem, a gateway, and/or another type of device, which also causes the CPE to go offline for a period of time.

Some solutions to this problem have been proposed, such as a mobile backup Internet access service, which would enable the user to have connectivity even during network and power outages. Unfortunately, a temporary mobile backup network connection, which may include use of a mobile device or a separate fixed wireless access (FWA) device, may not be as robust as the user's primary wired broadband connection, for example. Additionally, a temporary or backup network connection may not be able to adequately handle the usage requirements for all connected devices in a home, household, or the like, for example. In this regard, the temporary or backup network connection may be unable to support various performance metrics and values (e.g., bandwidth, throughput, latency, and/or other types of quality of service (QoS) parameters/values) offered by the primary network connection and network, such as a broadband network connection.

Other issues may arise during these situations, such as network congestion occurring at the time a backup network connection is established, during the use of the backup network connection, as well as during a switchover back to the primary network connection when the primary network connection is reestablished.

According to exemplary embodiments, a backup and restorative connectivity service is described. According to an exemplary embodiment, the backup and restorative connectivity service may be implemented by a CPE device. The CPE device may operate in a home, a business, an enterprise, an over-the-top (OTT), or other type of similar network environment. For example, the CPE device may be implemented as a gateway device, a wireless router, an FWA device, a home next generation Node B (gNB), a home evolved Node B (eNB), a home enhanced Long Term Evolution (eLTE) eNB, a small cell device (e.g., a picocell device, a microcell device, etc.), or a similar type of wireless access point (WAP) that may provide a backup network connection to a backup or secondary network. According to various exemplary embodiments, the CPE device may or may not provide both primary network connection (e.g., to include wired, optical fiber, etc.) and a wireless or cellular backup network connection. According to another exemplary embodiment, the backup and restorative connectivity service may be implemented by a non-CPE device. For example, the non-CPE device may be implemented by an end device, such as a mobile phone, a wireless router (e.g., a residential wireless router, a business wireless router, etc.), gateway device (e.g., a residential or business gateway, etc.), or similar type of radio device that may be configured to provide a backup Internet connection.

According to an exemplary embodiment, the backup and restorative connectivity service may include calculating a backup communication schedule for traffic of the backup Internet connection. According to an exemplary embodiment, the backup communication schedule may be calculated based on various types of data. For example, the data may include historical data, current data, and/or prospective data. According to an exemplary implementation, the data may include user(s) preference data, end device profile data, environmental data, date and time data, end device usage data, network state data, application service data, and/or other types of data that may assist in managing switchover procedures, prioritizing access, minimizing network congestion, and the like for end devices, as described herein.

According to an exemplary embodiment, the backup and restorative connectivity service may calculate the backup communication schedule based on various rules and/or policies. For example, the backup and restorative connectivity service may apply a rule or a policy relating to urgency and/or importance of an end device, an end device application, a particular communication in view of context data, and/or the like. According to another example, the backup and restorative connectivity service may apply a rule or a policy relating to a scoring system (e.g., based on user(s) preferences, history, dynamic weighting, fairness, etc.), as described herein. According to an exemplary embodiment, the backup and restorative connectivity service may include artificial intelligence and/or machine learning (AI/ML) logic. For example, the AI/ML logic may, in whole or in part, calculate the backup communication schedule, evaluate or analyze the data or a sub-group of the data, and/or make determinations regarding various operations associated with network access and use of the backup network connection during the outage and switchover back to the primary network connection when the outage is over.

In view of the foregoing, the backup and restorative connectivity service may address various issues associated with a network outage and/or a power outage. For example, the backup and restorative connectivity service may mitigate network congestion during switchover periods (e.g., primary to secondary network connection, secondary to primary network connection), as described herein. The backup and restorative connectivity service may also prevent high priority traffic from being subject to delays, prioritize network access by end devices to the backup or temporary network connection, ensure access fairness without undue complexity and overhead that typically bogs down network access for connected end devices under traditional packet prioritization mechanisms, provide an incident and need-based connectivity queue, and enable the user to influence end device connectivity during the outage, as described herein. As opposed to following static rules, the backup and restorative connectivity service may enable users with increased control of their end-to-end QoS for end devices in their home or another type of locale while operating on a limited network connection based on the application of various types of data and rules, as described herein.

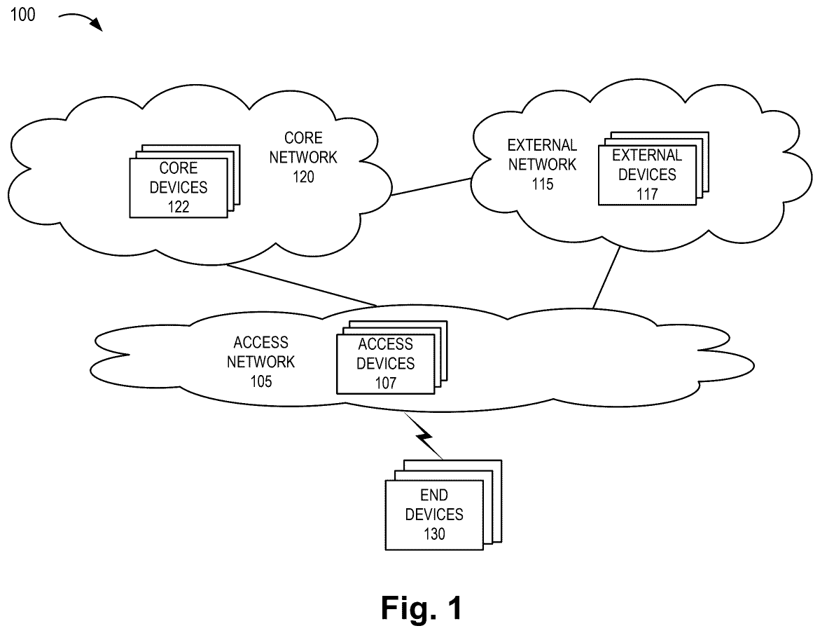

FIG. 1 is a diagram illustrating an exemplary environment 100 in which an exemplary embodiment of backup and restorative connectivity service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), an optical network, a wired network, etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, network slice, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the backup and restorative connectivity service may use at least one of these planes of communication. According to various exemplary implementations, the interface of the network device may be a service-based interface, a reference point-based interface, an Open Radio Access Network (O-RAN) interface, a Fifth Generation (5G) interface, another generation of interface (e.g., 5G Advanced, Sixth Generation (6G), Seventh Generation (7G), etc.), or some other type of network interface (e.g., proprietary, etc.).

Access network 105 may include one or multiple networks of one or multiple types and technologies. For example, access network 105 may be implemented to include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a Fourth Generation (4G) or 4.5 RAN, etc.). Access network 105 may communicate with and/or include other types of access networks, such as, for example, a Wi-Fi® network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 105.

Depending on the implementation, access network 105 may include one or multiple types of network devices, such as access devices 107. For example, access device 107 may include a gNB, an eLTE eNB, an eNB, a radio network controller (RNC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), another type of wireless node (e.g., a WiFi/Wi-Fi® device, a hotspot device, a Bluetooth® device, a Zigbee® device, a Z-Wave® device, a Thread device, a Matter device, a LoRA® device, an ultra-wideband (UWB)-enabled device, etc.) that provides a wireless access service, or another type of network device that provides a transport service (e.g., routing and forwarding), such as a router, a switch, or another type of layer 3 (e.g., network layer of the Open Systems Interconnection (OSI) model) network device.

External network 115 may include one or multiple networks of one or multiple types and technologies that provides an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a MEC network, a fog network, the Internet, a packet data network (PDN), a service provider network, the World Wide Web (WWW), an IMS network, a Rich Communication Service (RCS) network, a software defined (SD) network, a virtual network, a packet-switched network, a data center, or other type of network that may provide access to and may host an end device application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a network slice selection function (NSSF), a network repository function (NRF), a policy control function (PCF), a network data analytics function (NWDAF), a network exposure function (NEF), a service capability exposure function (SCEF), a lifecycle management (LCM) device, an application function (AF), a mobility management entity (MME), a packet gateway (PGW), an enhanced packet data gateway (ePDG), a serving gateway (SGW), an application function (AF), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a phablet, a wearable device (e.g., a watch, glasses, etc.), a computer, a gaming device, a music device, an IoT device, a drone, a smart device, a television, a set top box, a media player or streaming device, or another type of wireless device (e.g., another type of user equipment (UE)). End device 130 may be configured to execute various types of software (e.g., applications, programs, etc.). The number and the types of software may vary among end devices 130. End devices 130 may include “edge-aware” and/or “edge-unaware” application service clients. For purposes of description, end device 130 is not considered a network device.

According to an exemplary embodiment, at least some of end devices 130 may include logic of the backup and restorative connectivity service, as described herein. For example, the backup and restorative connectivity service may be provided by a smartphone, a tablet, a computer, or a similar type of user-operated device. According to another example, a CPE device, such as a gateway device, a wireless router, an FWA device, a home (gNB) or similar type of wireless station, a small cell device, a WAP, or the like, may provide the backup and restorative connectivity service.

According to some exemplary embodiments, the CPE may provide a portion of the backup and restorative connectivity service while end device 130 may provide the backend connection. For example, a Wi-Fi® router may calculate the backup queue, manage access and use of the backup network, determine when a switchover occurs, etc., while a mobile phone may provide the backup network connection on behalf of other end devices 130. The Wi-Fi® router may establish a wireless connection with the mobile phone and route the traffic from end device 130 to the mobile phone, and vice versa.

According to other exemplary embodiments, end device 130 or the CPE may provide the entirety of the backup and restorative connectivity service. For example, a cellular and Wi-Fi® router may calculate the backup queue, manage switchovers between the primary network and the secondary or backup network, manage access and use of the primary and secondary network connections, among other functions or operations associated with the backup and restorative connectivity service, as described herein.

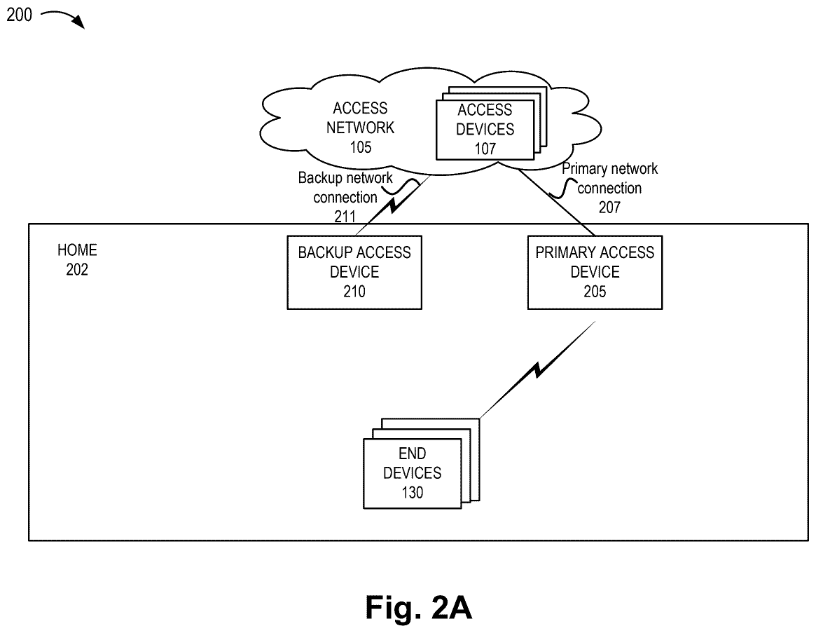

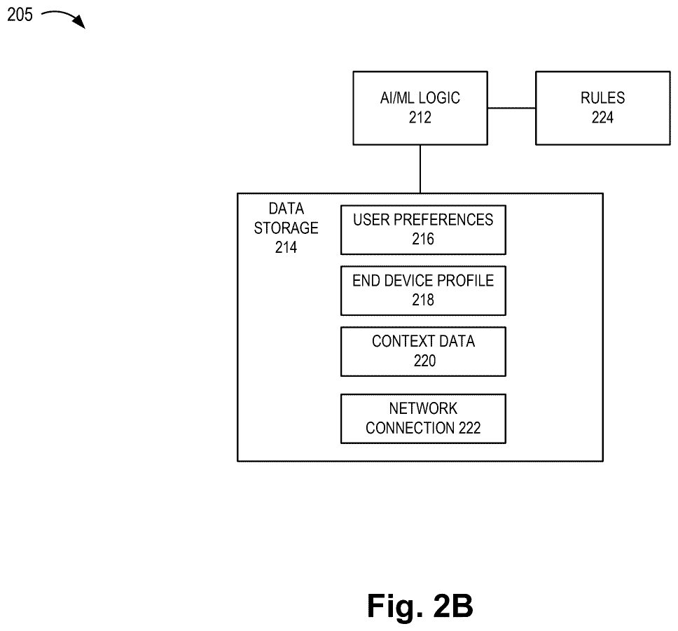

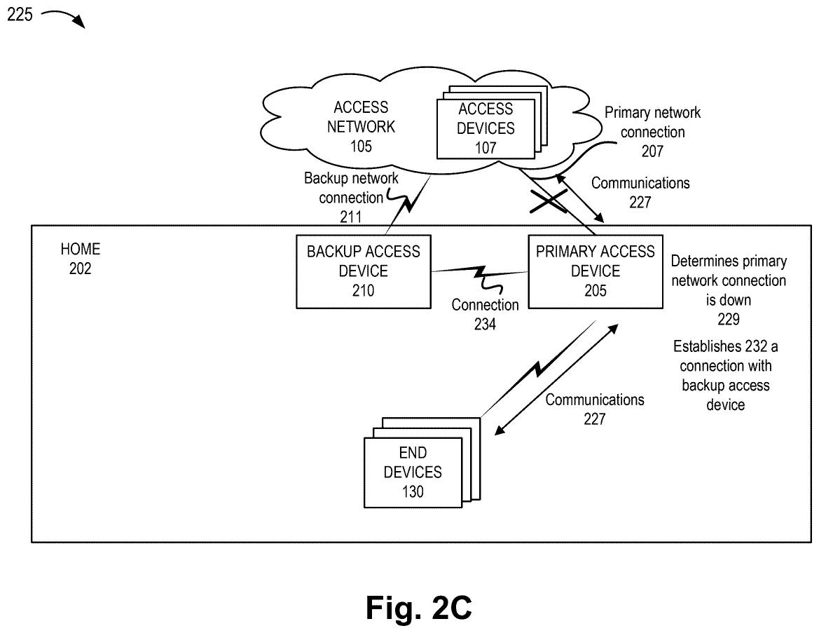

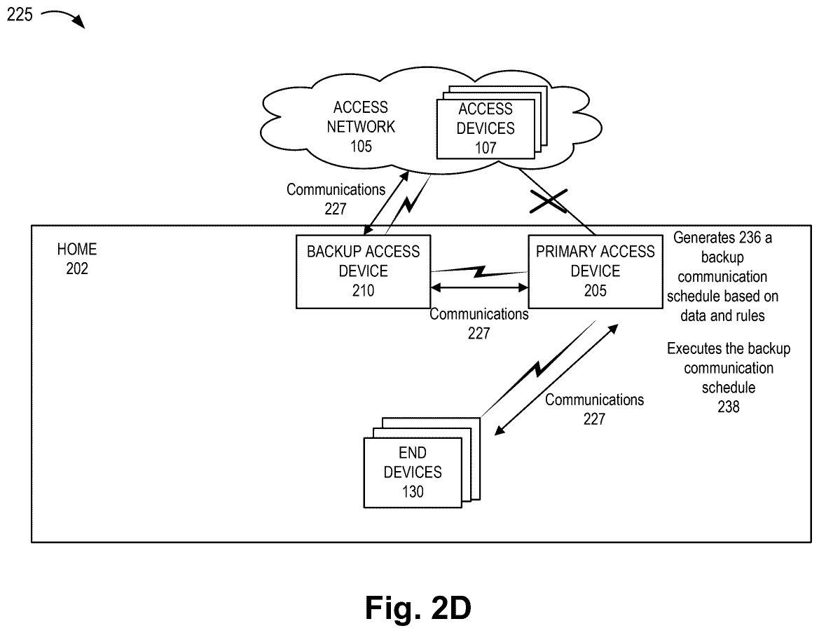

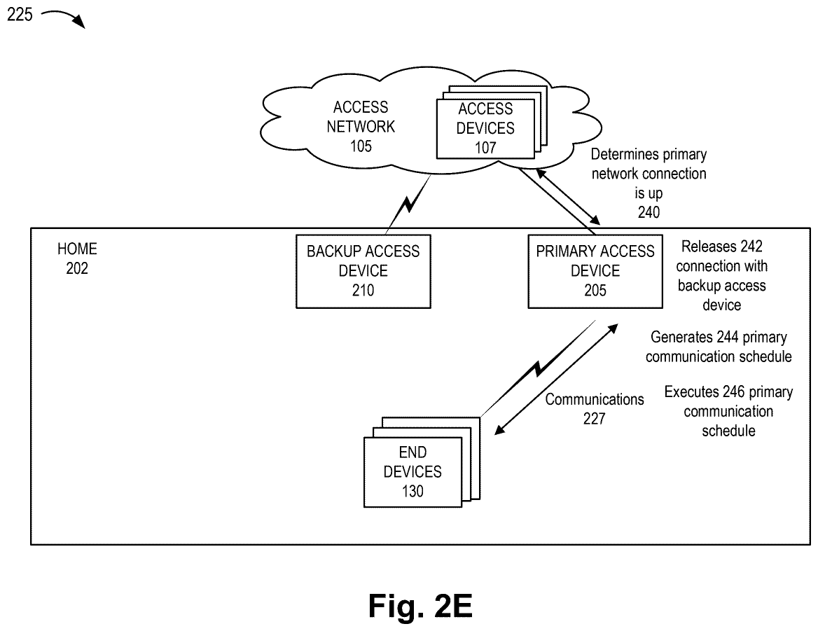

FIG. 2A is a diagram illustrating an exemplary environment 200 in which an exemplary embodiment of the backup and restorative connectivity service may be implemented. As illustrated, according to this example, environment 200 includes a locale, such as a home 202. According to other examples, environment 200 may include a different locale, such as a place of business, in an enterprise setting, an OTT environment, or the like. Home 202 may be a residence of a customer or a user. The customer or the user may subscribe to a network service with a network service operator or similar type of entity. For example, the network service may include an Internet service.

As illustrated, home 202 may include end device 130, which has been previously described. Additionally, home 202 may include a primary access device 205 and a backup access device 210.

According to an exemplary embodiment, primary access device 205 may be implemented as a router, a gateway device, or similar type of CPE device. For example, the router may include a Wi-Fi® router or the gateway device may include a Wi-Fi® router and a modem. According to an exemplary embodiment, primary access device 205 may include logic of the backup and restorative connectivity service, as described herein. Primary access device 205 may provide a primary network connection 207. For example, primary network connection 207 may include a broadband Internet connection, a fiber optic connection, or the like. Although not illustrated, primary network connection 207 may involve one or multiple network devices (e.g., an aggregator device, a fiber switch, etc.). In this regard, primary access device 205 may not have a direct connection with access network 105/access device 107.

According to an exemplary embodiment, backup access device 210 may be implemented as a particular type of end device 130, such as a mobile phone, a smartphone, or similar type of UE that includes similar cellular capabilities and can provide a backup Internet connection. According to other exemplary embodiments, backup access device 210 may be implemented as an FWA, a home gNB, or another type of cellular device. According to some exemplary embodiments, backup access device 210 may be an in-home device or reside outside of home 202 (e.g., a network device). According to an exemplary embodiment, backup access device 210 may include logic of the backup and restorative connectivity service, as described herein. Backup access device 210 may provide a backup network connection 211. For example, backup network connection 211 may include a wireless or cellular connection. According to some exemplary implementations, backup access device 210 may have a direct connection with access network 105/access device 107. According to an exemplary embodiment, backup network connection 211 provides a lower performance of connectivity (e.g., in terms of bandwidth, throughput, latency, error rate, etc.) compared to primary network connection 207.

As further illustrated, home 202 may connect to other networks, as described in FIG. 1, such as access network 105, other networks not illustrated (e.g., core network 120, external network 115, etc.), and network devices (e.g., access devices 107) as well as other network devices not illustrated (e.g., external devices 117, core devices 122, etc.).

The number and type of devices included in home 202 are exemplary. According to other embodiments, there may be additional, fewer, and/or different devices than those illustrated and described. Additionally, the number, the type, and the arrangement of communication links between devices and networks are exemplary.

FIG. 2B is a diagram illustrating exemplary functional components of primary access device 205. As illustrated, primary access device 205 may include AI/ML logic 212, data storage 214, and rules 224. According to other exemplary embodiments, primary access device 205 may include additional, fewer, and/or different functional components pertaining to an exemplary embodiment of the backup and restorative connectivity service. Additionally, or alternatively, one or more functional components may be combined and/or one or more operations, functions, and/or subservices may be divided into one or more dedicated functional components not illustrated.

AI/ML logic 212 may include an AI/ML model that may provide or support one or multiple sub-services of an exemplary embodiment of the backup and restorative connectivity service, as described herein. For example, the sub-services of the backup and restorative connectivity service may include a switchover connection service. The switchover connection service may manage end device 130 network connectivity via primary access device 205 to the primary and backup network connections. Backup and restorative connectivity service may include other sub-services pertaining to minimizing network congestion during a switchover and use of a backup network connection by end devices 130 via primary access device 205 and backup access device 210, prioritizing access and use of the backup network connection, connection monitoring, and other operations relating to backup and primary connection management, as described herein.

According to an exemplary embodiment, the AI/ML model may be implemented as a neural network model (NNM), a Generalized Linear Model (GLM), a Decision Tree, or another type of learning-based algorithm. According to an exemplary embodiment, the backup and restorative connectivity service may use an optimization algorithm, such as a reinforcement learning algorithm or another type of learning algorithm (e.g., supervised learning, etc.). The goal of the optimization may be configurable. For example, the optimization may relate to minimization of network congestion, prioritization of end device 130 access to backup network connection, and/or prioritization of traffic. According to other examples, the optimization may relate to a QoS metric (e.g., throughput, bandwidth, delay, etc.) and/or service level agreement (SLA) adherence associated with end device 130 and/or an application service/traffic associated with end device 130. According to yet other examples, the optimization may relate to device resource utilization (e.g., battery, computational, communication interface associated with backup access device 210, end device 130, etc.). According to some exemplary embodiments, AI/ML logic 212 may include algorithms that are not AI/ML-based which may provide, calculate, and/or support one or multiple sub-services of the backup and restorative connectivity service, as described herein.

Data storage 214 may include a storage device that stores data used by AI/ML logic 212. For example, data storage 214 may store user preference data 216, end device profile data 218, context data 220, and network connection data 222. According to other exemplary embodiments, data storage 214 may store fewer, additional, and/or different instances of data.

According to an exemplary embodiment, primary access device 205 may include a user interface that enables a user to configure (e.g., add, delete, edit, etc.) data, as described herein. For example, the user of home 202 may be able to set user preference data 216 via the user interface. According to another example, the user of home 202 may be able to enter or augment end device profile data 218 or other types of data, as described herein. According to exemplary embodiment, primary access device 205 may obtain an instance of data via communication with backup access device 210. According to another exemplary embodiment, primary access device 205 may locally obtain and store data pertaining to access and use of a primary network by end devices 130. According to still other exemplary embodiments, primary access device 205 may obtain and store data from an upstream network device, such as access device 107, core device 122, etc. According to yet other exemplary embodiments, AI/ML logic 212 may output data and store such data in data storage 214. According to various exemplary embodiments, data storage 214 may store historical data, current data, and prospective data regarding certain types of data, as described herein. As an example, network connection data 222 may include historical, current, and prospective data.

User preference data 216 may include data that indicates a preference associated with the backup and restorative connectivity service by a user. For example, a user preference may indicate a ranking or a weighted list of priority regarding access and/or use of the backend network via backup access device 210 by end devices 130 of home 202. According to some examples, the ranking or the weighted list may be dynamic based on another parameter, such as time. For example, a priority may change depending on the day of the week and/or the time of the day (e.g., early morning, evening, afternoon, etc.). Additionally, or alternatively, the parameter may relate to other types of contextual data (e.g., weather-related, police/fire-related, etc.). According to another example, the user preference may indicate priority for a switchover of end device 130 from the primary network to the backup network and/or vice versa, priority of access and/or use of the backend network connection associated with battery driven end devices 130 and non-battery-driven end devices 130, preferences relating to power outages (which may include at home 202 and the primary network) or network outages in the primary network (e.g., when home 202 has power), and so forth.

End device profile data 218 may include data that indicates the number and type of end devices 130. For example, the type of end device 130 may specify a characteristic or aspect of end device 130, such as IoT, security, health and wellness, environmental sensor, lock, camera, doorbell, lights, streaming device, a television, a media player, etc. End device profile data 218 may indicate whether end device 130 is battery driven or a commercially powered device (e.g., plugs into an electrical outlet, non-battery-driven device, etc.). End device profile data 218 may indicate other aspects of end device 130, such as usage patterns. For example, the usage pattern may indicate frequency of communications during a time period, average size of data per communication, transmission characteristics (e.g., continuous, bursty, etc.), and/or other attributes regarding communications (e.g., necessary QoS, 5G QoS Identifier (5QI), and the like).

Context data 220 may include data that may influence decisions regarding network connectivity. For example, context data 220 may include network alarm data indicating unplanned outages (e.g., power, network, etc.) or network performance issues/degradation, weather (e.g., severe storms, hurricane, tornado, etc.) and disaster data, recent emergency communications in home 202 (e.g., fall detection service, a security alarm, fire/smoke detection, etc.), whether the user is in home 202 or away, and the like.

Network connection data 222 may include data indicating when the primary network is up or down. Network connection data 222 may include data relating to performance metrics (e.g., throughput, bandwidth, latency, error rate, etc.) pertaining to the primary network connection and other characteristics (e.g., intermittent, degraded, normal, etc.). Network connection data 222 may include similar data relating to performance metrics pertaining to the backup network connection, available bandwidth, throughput, latency, etc., and other characteristics.

Rules 224 may include data indicating rules and/or policies regarding determinants of the backup and restorative connectivity service, such as prioritization, switchover triggers or criteria, dynamic weighting or scoring based on changes between observations, identification of urgency and/or importance, issuance of fairness (e.g., in terms of access and/or use of the backup network connection, etc.), management of network congestion, and/or the like.

FIGS. 2C-2E are diagrams illustrating an exemplary process 225 of an exemplary embodiment of the backup and restorative connectivity service according to an exemplary scenario. As illustrated, process 225 may be implemented in environment 200 that includes a device that provides an exemplary embodiment of the backup and restorative connectivity service.

Referring to FIG. 2C, according to an exemplary scenario, assume that end devices 130 have communications 227 occurring via primary access device 205 and primary network connection 207. For example, communications 227 may include one or multiple different sessions with external device 117 via access network 105. Subsequently, primary network connection 207 goes down (illustrated as an X), and primary access device 205 determines that the primary network connection is down 229. If not already established, in response, primary access device 205 may establish 232a connection with backup access device 210, such as an intermediary connection 234. According to some exemplary embodiments, backup access device 210 may confirm with primary access device 205 that backup network connection 211 is available for the backup and restorative connectivity service.

Referring to FIG. 2D, primary access device 205 may generate 236 a backup communication schedule based on data and rules. For example, as previously described, primary access device 205 may generate the backup communication schedule for traffic based on user preference data 216, end device profile data 218, context data 220, and network connection data 222, as well as rules 224. According to some exemplary embodiments, primary access device 205 may generate an uplink backup communication schedule and a downlink backup communication schedule pertaining to uplink and downlink traffic, respectively. According to some exemplary embodiments, backup access device 210 may provide state information regarding backup network connection 211, such as available bandwidth and/or other types of metrics and/or characteristics, as described herein.

According to some exemplary scenarios, the generation of the backup communication schedule may include prioritizing access and use of one end device 130 over another end device 130, as described herein. For example, in an attempt to mitigate network congestion when the switchover occurs during which all end devices 130 may attempt to get connected, primary access device 205 may prioritize traffic and/or end device 130 over other traffic and/or another end device 130. Alternatively, the prioritization may occur after the switchover is completed during which end devices 130 share the limited capabilities of backup network connection 211.

According to other exemplary scenarios, primary access device 205 may generate the backup communication schedule that includes prioritization for other reasons, such as the nature of the communication or end device 130 (e.g., in terms of importance or urgency) relative to another communication or end device 130 based on context data 220, user preference data 216, end device profile data 218, and/or rules 224. By way of example, restarting a video stream after a connectivity outage may not be as important as making sure a home security system is online, that a fall detection service is operational, that a carbon monoxide alert is transmitted, that a water sensor during a storm can communicate, or that surveillance cameras, locks on doors are connected and operational. In some cases, end device 130 may need to perform various security mechanisms (e.g., authentication, authorization, etc.) as a part of or before relevant data is transmitted, for example. In this way, certain end devices 130 may not have to compete for bandwidth during dynamic network conditions associated with backup network connection 211 or during the restoration of primary network connection 207, which may not be up to its full capacity.

According to yet other exemplary scenarios, primary access device 205 may generate the backup communication schedule that includes prioritization based on a customer preference that designates all or some battery driven end devices 130 over all or some non-battery driven end devices 130.

According to an exemplary embodiment, primary access device 205 may select and apply a scheduling algorithm based on current and/or prospective circumstances associated with traffic demands, context data 220, and so forth. For example, primary access device 205 may determine to use a prioritized-based round robin queue, a proportional-fair scheduling algorithm, a modified largest weighted delay first (M-LWDF) scheduling algorithm, a proportional fair scheduling algorithm, or the like, as well as other mechanisms, such as channel-independent scheduling (CIS), channel-dependent scheduling (CDS), weighted fair queueing (WFQ), user prioritization, Q-learning, fairness, and so forth.

As previously described, primary access device 205 may apply rules 224 for generating the backup communication schedule. For example, according to various exemplary scenarios, the backup and restorative connectivity service may derive importance, priority, and other determinants based on reactive, predictive-reactive, and/or proactive approaches, as well as a composite rule and/or policy performance methodology. For example, rules 224 may include a simplest task first approach in which a higher priority may be afforded to end devices 130 that require low bandwidth allocation for a minimal amount of time (e.g., IoT or sensor reporting).

In response to the generation of the backup communication schedule, primary access device 205 may execute the backup communication schedule 238. For example, for uplink traffic, primary access device 205 may forward or transmit traffic to backup access device 210 for further transmission. For downlink traffic, primary access device 205 may forward or transmit traffic to end device 130. Primary access device 205 may continue to generate subsequent backup communication schedules and execute them until it is determined that primary network connection 207 is up. In this regard, primary access device 205 may periodically or continuously monitor, for example, the state of primary network connection 207. According to other exemplary scenarios, if primary network connection 207 is partially up (e.g., in a degraded state), primary access device 205 may use both primary network connection 207 and backup network connection 211 for end device traffic.

Referring to FIG. 2E, primary access device 205 may determine that the primary network connection is (fully) up 240. In response, primary access device 205 may perform a switchover procedure that may include releasing 242 the intermediary connection with backup access device. Primary access device 205 may generate 244 a primary communication schedule for traffic and execute 246 the primary communication schedule. According to some exemplary embodiments, primary access device 205 may generate the primary communication schedule, in whole or in part, based on AI/ML logic 212, data stored in data storage 214, and rules 224.

According to other exemplary embodiments, in view of the capabilities of primary network connection 207, primary access device 205 may not generate the primary communication schedule based on AI/ML logic 212, data stored in data storage 214, and rules 224. Primary access device 205 may continually update historical data, usage information, and other relevant information that may be stored in data storage 214.

FIGS. 2C-2E are diagrams illustrating an exemplary process 215 of an exemplary embodiment of the backup and restorative connectivity service. According to other exemplary embodiments and scenarios, the process may include additional operations, fewer operations, and/or different operations.

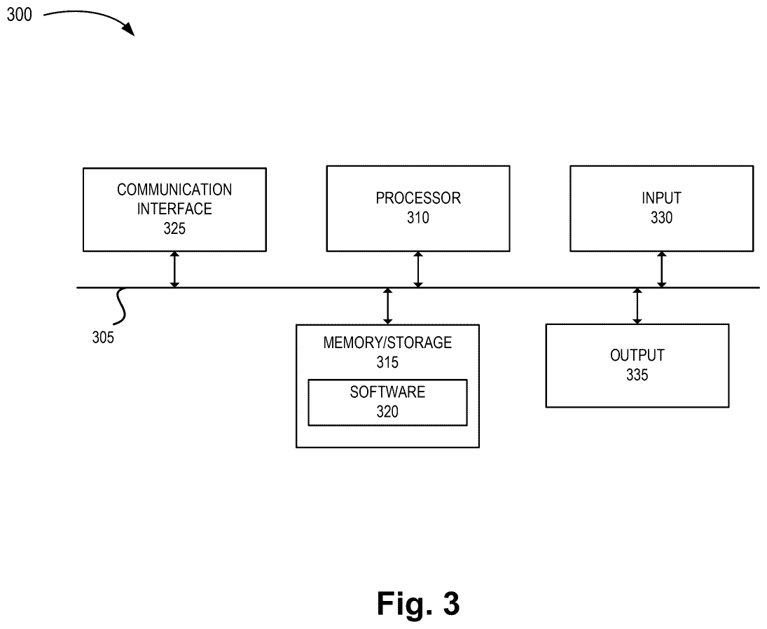

FIG. 3 is a diagram illustrating exemplary components of a device 300 that may be included in one or more of the devices described herein. For example, device 300 may correspond to access device 107, external device 117, core device 122, end device 130, primary access device 205, backup access device 210, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, a solid state drive, mass storage, off-line storage, cloud storage, or some other type of storing medium. Memory/storage 315 may store data, software, and/or instructions related to the operation of device 300.

Software 320 includes an application or a program that provides a function and/or a process. As an example, with reference to primary access device 205, software 320 may include an application that, when executed by processor 310, provides a function and/or a process of backup and restorative connectivity service, as described herein. Additionally, with reference to backup access device 210, software 320 may include an application that, when executed by processor 310, provides a function and/or a process of backup and restorative connectivity service, as described herein. Software 320 may also include firmware, middleware, microcode, hardware description language (HDL), and/or other form of instruction. Software 320 may also be virtualized. Software 320 may further include an operating system (OS) (e.g., Windows, Linux, Android, proprietary, etc.).

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions that are stored by memory/storage 315 cause processor 310 to perform a function or a process described herein. Alternatively, for example, according to other implementations, device 300 performs a function or a process described herein based on the execution of hardware (processor 310, etc.).

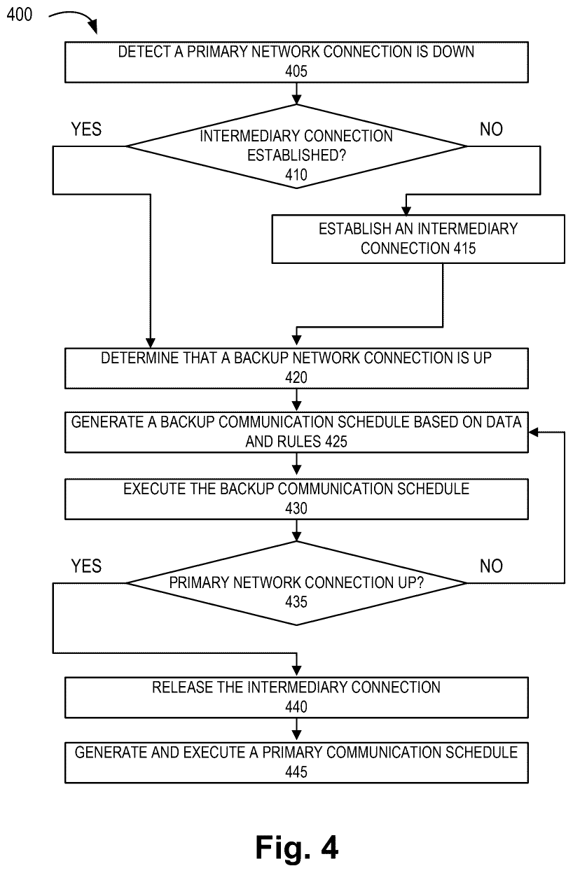

FIG. 4 is a flow diagram illustrating an exemplary process 400 of an exemplary embodiment of the backup and restorative connectivity service. According to an exemplary embodiment, process 400 may be implemented when the primary access device and the back access device are not integrated. For example, the primary access device does not provide a wireless or cellular backup or temporary connection. According to an exemplary embodiment, a CPE or another type of primary access device, as described herein (e.g., primary access device 205, etc.) may perform a step of process 400. According to an exemplary implementation, processor 310 executes software 320 to perform a step of process 400, as described herein. Alternatively, a step may be performed by execution of only hardware.

In block 405, the primary access device may detect that a primary network connection is down. For example, primary access device 205 may determine whether primary network connection 207 is down due to a power outage or other reasons, as described herein.

In block 410, the primary access device may determine whether an intermediary connection is established. For example, primary access device 205 may determine whether there is the intermediary connection 234 with backup access device 210.

When the primary access device determines that the intermediary connection is not established (block 410—NO), the primary access device may establish the intermediary connection (block 415). For example, primary access device 205 may establish the intermediary connection 234 with backup access device 210. Process 400 may continue to block 420.

When the primary access device determines that the intermediary connection is established (block 410—YES), the primary access device may determine that the backup network connection is up (block 420). For example, backup access device 210 may communicate (e.g., via the intermediary connection 234) to primary access device 205 that backup network connection 211 is available. Backup access device 210 may also provide connection state information, metric information (e.g., available bandwidth, etc.), and/or other characteristics associated with backup network connection 211, as described herein.

In block 425, the primary access device may generate a backup communication schedule based on data and rules. For example, primary access device 205 may generate the backup communication schedule based on user preferences, end device profile data, context data, network connection data, and rules, as described herein.

In block 430, the primary access device may execute the backup communication schedule. For example, primary access device 205 may transmit and receive traffic associated with one or multiple end devices 130 via backup network connection 211, backup access device 210, and the intermediary connection 234.

In block 435, the primary access device may determine whether the primary network connection is up. When the primary access device determines that the primary network connection is not up (i.e., still down) (block 435—NO), process 400 may return back to block 425.

When the primary access device determines that the primary network connection is up (block 435—YES), the primary access device may release the intermediary connection (block 440).

In block 445, the primary access device may generate and execute a primary communication schedule. For example, primary access device 205 may transmit and/or receive traffic to and from one or more end devices 130 via the primary network connection 207.

According to various exemplary embodiments, primary access device 205 may or may not generate the primary communication schedule, in whole or in part, based on the data and rules, as described herein.

FIG. 4 illustrates an exemplary process of the backup and restorative connectivity service, according to other exemplary embodiments, the backup and restorative connectivity service may perform additional operations, fewer operations, and/or different operations than those illustrated and described. For example, according to some exemplary embodiments, the primary access device may use both the primary network connection and the backup network connection when the primary network connection is underperforming (e.g., operating in a degraded state).

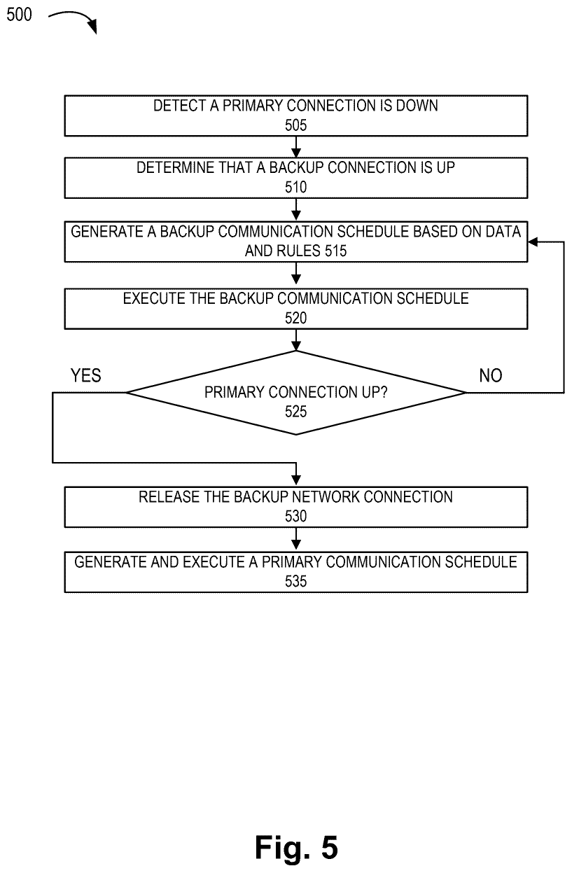

FIG. 5 is a flow diagram illustrating an exemplary process 500 of an exemplary embodiment of the backup and restorative connectivity service. According to an exemplary embodiment, process 500 may be implemented when the primary access device and the back access device are integrated. For example, the primary access device may provide both the primary network connection and the backup or temporary network connection, as described herein. According to an exemplary embodiment, a CPE or another type of primary access device, as described herein (e.g., primary access device 205, etc.) may perform a step of process 500. According to an exemplary implementation, processor 310 executes software 320 to perform a step of process 500, as described herein. Alternatively, a step may be performed by execution of only hardware.

In block 505, the primary access device may detect that a primary network connection is down. For example, primary access device 205 may determine whether the primary network connection 207 is down due to a power outage or other reasons, as described herein.

In block 510, the primary access device may determine that a backup network connection is up. For example, primary access device 205 may establish or determine that a cellular or wireless connection is available.

In block 515, the primary access device may generate a backup communication schedule based on data and rules. For example, primary access device 205 may generate the backup communication schedule based on user preferences, end device profile data, context data, network connection data, and rules, as described herein.

In block 520, the primary access device may execute the backup communication schedule. For example, primary access device 205 may transmit and receive traffic associated with one or multiple end devices 130 via the backup network connection 211.

In block 525, the primary access device may determine whether the primary connection is up. When the primary access device determines that the primary network connection is not up (i.e., still down) (block 525—NO), process 500 may return back to block 515.

When the primary access device determines that the primary network connection is up (block 525—YES), the primary access device may release the backup network connection (block 530).

In block 535, the primary access device may generate and execute a primary communication schedule. For example, primary access device 205 may transmit and/or receive traffic to and from one or more end devices 130 via the primary network connection 207. According to various exemplary embodiments, primary access device 205 may or may not generate the primary communication schedule, in whole or in part, based on the data and rules, as described herein.

FIG. 5 illustrates an exemplary process of the backup and restorative connectivity service, according to other exemplary embodiments, the backup and restorative connectivity service may perform additional operations, fewer operations, and/or different operations than those illustrated and described. For example, according to some exemplary embodiments, primary access device 205 may use both the primary network connection and the backup network connection when the primary network connection is underperforming (e.g., operating in a degraded state). According to various exemplary embodiments, process 500 may be implemented regardless of whether the locale (e.g., home, business place, etc.) at which primary access device 205 is situated, has a power outage or not. For example, when there is a power outage at a home, some implementations of primary access device 205 may be battery driven. According to other examples, when there is electrical power at the home, some implementations of primary access device 205 may be commercially powered (e.g., plugs into an electrical outlet, non-battery-driven, etc.).

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations. For purposes of description and claims, the term “WiFi” may include Wi-Fi® (e.g., an IEEE 802.x standard) and a non-standard wireless local area network (WLAN) technology.

In addition, while series of blocks have been described regarding the processes illustrated in FIGS. 4 and 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
providing, by a device, Internet access to end devices via a primary network connection;
detecting, by the device, that the primary network connection is down;
determining, by the device, that a backup network connection to a radio access network is available, wherein the backup network connection has a lower performance than the primary network connection;
generating, by the device in response to the determining, a backup communication schedule for traffic associated with the end devices based on at least one of user preference data, end device profile data, context data, or network connection data; and
executing, by the device, the backup communication schedule for the traffic via the backup network connection.

2. The method of claim 1, wherein the backup communication schedule includes a prioritization of some of the traffic over a remainder portion of the traffic.

3. The method of claim 1, wherein the user preference data includes data indicating different prioritizations among the end devices regarding access and use of the backup network connection during an outage.

4. The method of claim 1, wherein the network connection data includes data indicating one or more performance metrics associated with the backup network connection.

5. The method of claim 1, wherein the end device profile data indicates for each of the end devices, a type of end device and whether the end device is battery-driven or non-battery-driven.

6. The method of claim 1, wherein the context data includes data relating to weather, unplanned network outages, and an emergency communication from one of the end devices.

7. The method of claim 1, further comprising:
detecting, by the device after the executing, that the primary network connection is up; and
switching, by the device, the traffic back to the primary network connection.

8. The method of claim 1, wherein the device includes a Fifth Generation (5G) WiFi router or a gateway device.

9. A device comprising:
a processor that is configured to:
provide Internet access to end devices via a primary network connection;
detect that the primary network connection is down;
determine that a backup network connection to a radio access network is available, wherein the backup network connection has a lower performance than the primary network connection;
generate, in response to the determination, a backup communication schedule for traffic associated with the end devices based on at least one of user preference data, end device profile data, context data, or network connection data; and
execute the backup communication schedule for the traffic via the backup network connection.

10. The device of claim 9, wherein the backup communication schedule includes a prioritization of some of the traffic over a remainder portion of the traffic.

11. The device of claim 9, wherein the user preference data includes data indicating different prioritizations among the end devices regarding access and use of the backup network connection during an outage.

12. The device of claim 9, wherein the network connection data includes data indicating one or more performance metrics associated with the backup network connection.

13. The device of claim 9, wherein the end device profile data indicates for each of the end devices, a type of end device and whether the end device is battery-driven or non-battery-driven.

14. The device of claim 9, wherein the context data includes data relating to weather, unplanned network outages, and an emergency communication from one of the end devices.

15. The device of claim 9, wherein the processor is further configured to:
detect, after the execution, that the primary network connection is up; and
switch the traffic back to the primary network connection.

16. The device of claim 9, wherein the device includes a Fifth Generation (5G) WiFi router or a gateway device.

17. A non-transitory computer-readable storage medium storing instructions executable by a processor of a device, wherein the instructions are configured to:
provide Internet access to end devices via a primary network connection;
detect that the primary network connection is down;
determine that a backup network connection to a radio access network is available, wherein the backup network connection has a lower performance than the primary network connection;
generate, in response to the determination, a backup communication schedule for traffic associated with the end devices based on at least one of user preference data, end device profile data, context data, or network connection data; and
execute the backup communication schedule for the traffic via the backup network connection.

18. The non-transitory computer-readable storage medium of claim 17, wherein the instructions comprise further instructions configured to:
detect, after the execution, that the primary network connection is up; and
switch the traffic back to the primary network connection.

19. The non-transitory computer-readable storage medium of claim 17, wherein the backup communication schedule includes a prioritization of some of the traffic over a remainder portion of the traffic.

20. The non-transitory computer-readable storage medium of claim 17, wherein the user preference data includes data indicating different prioritizations among the end devices regarding access and use of the backup network connection during an outage.
